(19) United States
(12) Patent Application Publication
(10) Pub. No.: US 2026/0074348 A1
(43) Pub. Date: Mar. 12, 2026

(54) UNIVERSAL WASHER, FASTENING APPARATUS, AND BATTERY PACK

(71) Applicant: Samsung SDI Co., Ltd., Yongin-si (KR)

(72) Inventor: Sanghun Park, Yongin-si (KR)

(73) Assignee: Samsung SDI Co., Ltd., Yongin-si (KR)

(21) Appl. No.: 19/319,109

(22) Filed: Sep. 4, 2025

(30) Foreign Application Priority Data
Sep. 11, 2024 (KR) 10-2024-0124337

(51) Int. Cl. H01M 50/262; F16B 39/24; F16B 43/00; H01M 10/42; H01M 50/204; H01R 4/30

(52) U.S. Cl. CPC H01M 50/262; F16B 43/00; H01M 10/425; H01M 50/204; H01R 4/304; F16B 39/24; H01M 2010/4271

(57) ABSTRACT

Disclosed are a universal washer, a fastening apparatus, and a battery pack. The universal washer may be interposed between a fastening bolt and a fastening nut for fixing one or more connection members to be in contact with a lower surface of the one or more connection members and may be formed with a through hole through which a shaft at a lower part of a head of the fastening bolt passes. A concave curved portion may be formed in a peripheral portion of the through hole in a direction of travel of the shaft of the fastening bolt, and a flat rim portion may be formed on a rim of the universal washer.

### CROSS-REFERENCE TO RELATED APPLICATIONS

This present application claims priority to and the benefit under 35 U.S.C. § 119(a)-(d) of Korean Patent Application No. 10-2024-0124337, filed on Sep. 11, 2024, in the Korean Intellectual Property Office, the entire disclosure of which is incorporated herein by reference.

### FIELD

The present disclosure relates to a universal washer, a fastening apparatus, and a battery pack, and to a universal washer that supplements the flatness of a connection member through a curved portion formed thereon, a fastening apparatus, and a battery pack.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, terminal part connected to the electrode assembly, among other components. The herein information disclosed in this Background section is for enhancement of understanding of the background of the present disclosure, and therefore, it may contain information that does not constitute related (or prior) art.

### SUMMARY

An object of the present disclosure is to provide a universal washer that supplements the flatness of a connection member through a curved portion formed thereon, a fastening apparatus, and a battery pack.

However, the technical problem to be solved by the present disclosure is not limited to the herein problem, and other problems not mentioned herein, and aspects and features of the present disclosure that would address such problems, will be clearly understood by those skilled in the art from the description of the present disclosure herein.

A universal washer according to an embodiment of the present disclosure may be interposed between a fastening bolt and a fastening nut for fixing one or more connection members to be in contact with a lower surface of the one or more connection members and may be formed with a through hole through which a shaft at a lower part of a head of the fastening bolt passes. The universal washer may comprise a concave curved portion being formed in a peripheral portion of the through hole in a direction of travel of the shaft of the fastening bolt, and a flat rim portion being formed on a rim of the universal washer.

In embodiments, in a state in which the universal washer is placed on the fastening nut so that the concave curved portion is seated on a curved shape of the fastening nut, the fastening bolt and the fastening nut may be fastened, the curved shape being formed in the fastening nut to correspond to the concave curved portion.

In embodiments, the concave curved portion may be divided into a plurality of parts.

In embodiments, a size of an inner circumferential surface of the concave curved portion may be smaller than a size of an outer circumferential surface of the shaft of the fastening bolt.

In embodiments, the universal washer may be made of an elastic metal material.

In embodiments, the one or more connection members may include a first connection member and a second connection member.

In embodiments, the first connection member may be a tab connected to an electrode of a core pack including a plurality of battery cells.

In embodiments, the second connection member may be a busbar connected to a battery management system (BMS).

A fastening apparatus according to an embodiment of the present disclosure may include: a fastening bolt; a fastening nut fastened with the fastening bolt to fix one or more connection members; and a universal washer interposed to be in contact with a lower surface of the one or more connection members and formed with a through hole through which a shaft at a lower part of a head of the fastening bolt passes, a concave curved portion being formed in a peripheral portion of the through hole in a direction of travel of the shaft of the fastening bolt, and a flat rim portion being formed on a rim of the universal washer.

In embodiments, the fastening nut may have a curved shape formed therein to correspond to the concave curved portion, and in a state in which the universal washer is placed on the fastening nut so that the concave curved portion of the universal washer is seated on the curved shape of the fastening nut, the fastening bolt and the fastening nut may be fastened.

In embodiments, the concave curved portion of the universal washer may be divided into a plurality of parts.

In embodiments, in the universal washer, a size of an inner circumferential surface of the concave curved portion may be smaller than a size of an outer circumferential surface of the shaft of the fastening bolt.

In embodiments, the universal washer may be made of an elastic metal material.

In embodiments, the fastening apparatus may further include a spring washer interposed above the one or more connection members.

In embodiments, the fastening nut is not formed with an internal thread, and when the fastening bolt is fastened, the internal thread may be formed by tapping of an external thread formed on the shaft of the fastening bolt.

In embodiments, the one or more connection members may include a first connection member and a second connection member.

In embodiments, the first connection member may be a tab connected to an electrode of a core pack including plurality of battery cells.

In embodiments, the second connection member may be a busbar connected to a battery management system (BMS).

A battery pack according to an embodiment of the present disclosure may include the universal washer.

In embodiments, the universal washer may be interposed between the fastening bolt and the fastening nut for fixing a tab connected to an electrode of a core pack including a plurality of battery cells and a bus bar connected to a battery management system (BMS) to be in contact with a lower surface of the tab and the bus bar.

According to an embodiment of the present disclosure, since a curved portion is formed around a through hole of a universal washer, the unstable flatness of a connection member for battery power connection can be supplemented, thereby stably supplying power to a battery.

According to an embodiment of the present disclosure, since a curved shape is formed inside a fastening nut to correspond to the curved portion of the universal washer, a fastening bolt and the fastening nut are fastened in a state in which the universal washer is seated on the fastening nut, thereby more effectively supplementing the flatness of the connection member.

According to an embodiment of the present disclosure, since the curved portion of the universal washer is divided into a plurality of parts and serves as a spring, a tensile force is applied in a direction opposite to the direction of travel of the fastening bolt, thereby minimizing deformation between connection members and further strengthening the fastening force of the bolt.

### BRIEF DESCRIPTION OF THE DRAWINGS

The following drawings attached to the present specification illustrate an embodiment of the present disclosure, and further describe aspects and features of the present disclosure together with the detailed description of the present disclosure. Thus, the present disclosure should not be construed as being limited to the drawings:

FIG. 1A is an exploded view of a fastening apparatus in the related art;

FIG. 1B is a coupling view of the fastening apparatus in the related art;

FIG. 2 is a diagram illustrating a state in which the fastening apparatus in the related art is flatly coupled;

FIG. 3 is a diagram illustrating a state in which the fastening apparatus in the related art is unevenly coupled;

FIG. 4A is an exploded view of a fastening apparatus according to an embodiment of the present disclosure;

FIG. 4B is a coupling view of the fastening apparatus according to an embodiment of the present disclosure;

FIG. 5 is a diagram illustrating a state in which the fastening apparatus according to an embodiment of the present disclosure is flatly coupled;

FIG. 6 is a diagram illustrating a universal washer of the fastening apparatus according to an embodiment of the present disclosure;

FIG. 7 is a diagram illustrating a fastening nut of the fastening apparatus according to an embodiment of the present disclosure;

FIG. 8 is a diagram illustrating a state in which the universal washer of the fastening apparatus according to an embodiment of the present disclosure is seated on an upper part of the fastening nut; and

FIG. 9 is a diagram illustrating a state in which the fastening apparatus according to an embodiment of the present disclosure is unevenly coupled.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own disclosure in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed herein may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below”may encompass both upward and downward directions.

The terminology used herein is for the purpose of describing embodiments of the present disclosure and is not intended to limit the present disclosure.

The present disclosure will be described in detail with reference to the attached drawings.

The present disclosure is described herein with reference to the accompanying drawings.

In the case of a battery pack including a plurality of secondary batteries, a core pack including a plurality of battery cells and a battery management system (BMS) are connected to manage the charging and discharging of the plurality of battery cells. In such a case, when the core pack and the BMS are connected to each other, it is common to connect the core pack and the BMS by fastening connection members such as tabs or busbars by using bolts. In such a case, it is necessary to ensure that the connection parts of the core pack and the BMS can be stably coupled so that power can be stably supplied regardless of environmental conditions of a user.

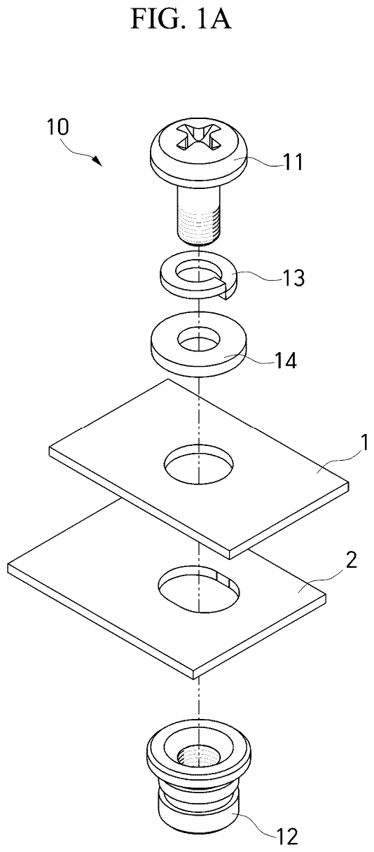

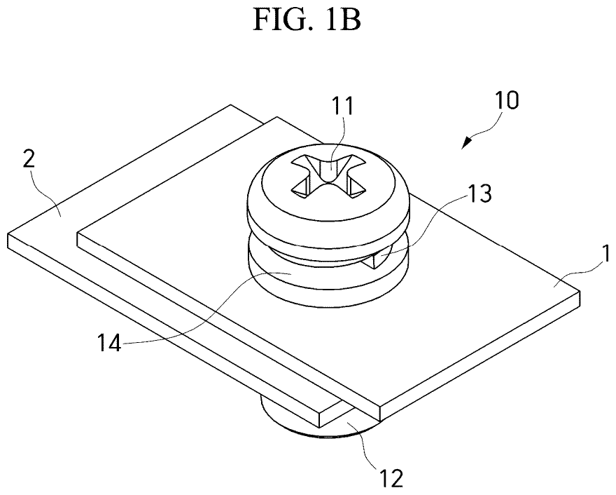

FIG. 1A is an exploded view of a fastening apparatus in the related art, and FIG. 1B is a coupling view of the fastening apparatus in the related art.

Referring to FIGS. 1A and 1B, a fastening apparatus 10 in the related art may include a fastening bolt 11, a fastening nut 12, a spring washer 13, and a flat washer 14.

The fastening bolt 11 and the fastening nut 12 are fastened to fix one or more connection members 1 and 2. In such a case, the connection members 1 and 2 fixed through the fastening bolt 11 and the fastening nut 12 may be a tab 1 or a busbar 2 used when a core pack including a plurality of battery cells and a battery management system (BMS) are connected to each other.

The spring washer 13 and the flat washer 14 may be interposed between the fastening bolt 11 and the connection members 1 and 2. The spring washer 13 has a coil shape twisted like a spring, and thus prevents loosening and detachment by a force caused by a shape being pressed, and the flat washer 14 protects the surface of the connection members 1 and 2 and distributes the pressure.

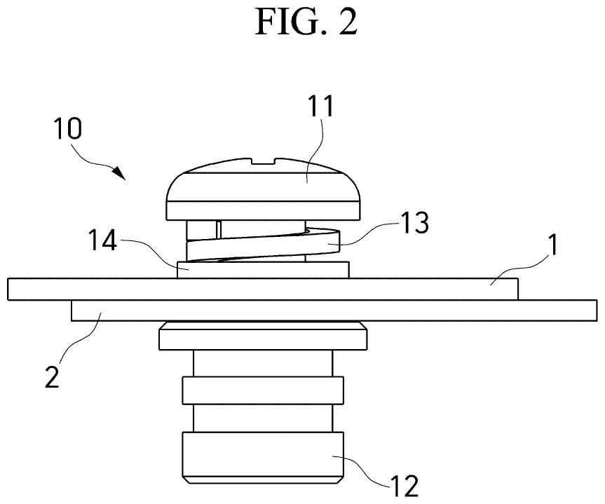

FIG. 2 is a diagram illustrating a state in which the fastening apparatus in the related art is flatly coupled.

Referring to FIG. 2, it can be confirmed that the fastening apparatus 10 in the related art is well-coupled to the connection members 1 and 2 flatly. In this case, a coupling portion of the connection members 1 and 2 and the fastening nut 12 is in good contact as a whole, so that stable contact resistance can be secured. However, when the fastening apparatus 10 in the related art is unevenly coupled to the connection members 1 and 2, a problem occurs.

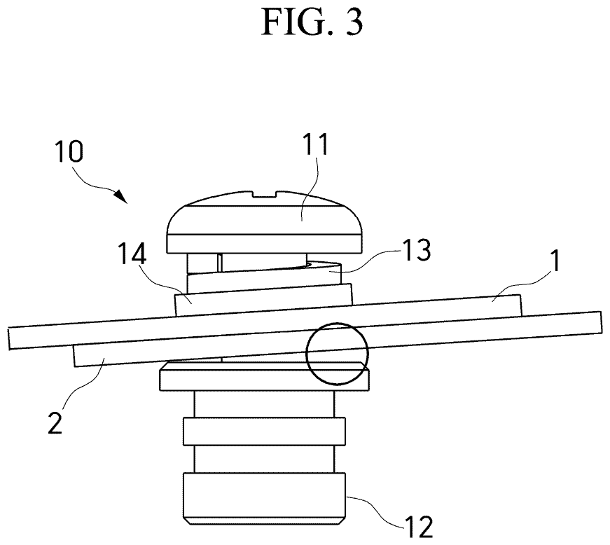

FIG. 3 is a diagram illustrating a state in which the fastening apparatus in the related art is unevenly coupled. Referring to FIG. 3, it can be confirmed that the fastening apparatus 10 in the related art is unevenly coupled to the connection members 1 and 2. The reason why the fastening apparatus 10 in the related art is unevenly coupled to the connection members 1 and 2 is because when the fastening bolt 11 is inserted, the center of a screw thread is forcibly aligned for fastening with the fastening nut 12, and the fastening bolt 11 and the fastening nut 12 may be coupled in a tilted state according to the flatness of the connection members 1 and 2 being the reference plane of the coupling.

In such a case, as shown in the part circled in FIG. 3, a part of the coupling part of the connection members 1 and 2 and the fastening nut 12 does not make proper contact and is lifted, resulting in unstable contact resistance.

Accordingly, when two electrodes of a battery are fastened using the fastening apparatus 10 in the related art, the contact resistances of the two electrodes are different, causing dispersion in the quality of each product.

Accordingly, in the fastening apparatus 10 in the related art, it was common to try to secure the flatness of the connection members 1 and 2 being a reference plane so that the fastening apparatus 10 can be flatly coupled as illustrated in FIG. 2 when the fastening bolt 11 and the fastening nut 12 are fastened to each other.

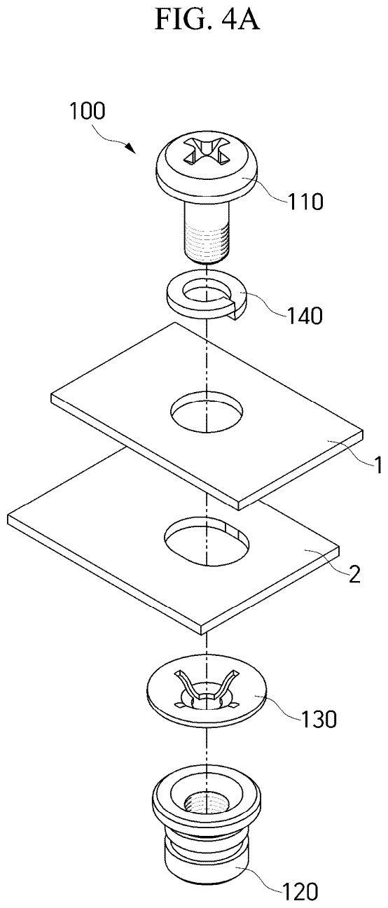

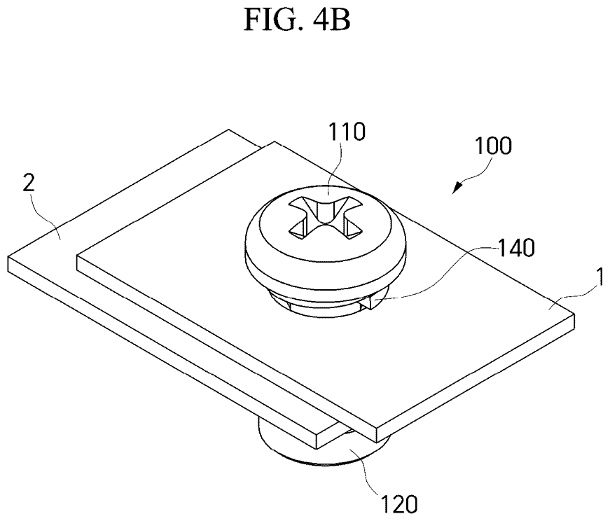

FIG. 4A is an exploded view of fastening apparatus according to an embodiment of the present disclosure, and FIG. 4B is a coupling view of the fastening apparatus according to an embodiment of the present disclosure.

Referring to FIGS. 4A and 4B, a fastening apparatus 100 according to an embodiment of the present disclosure may include a fastening bolt 110, a fastening nut 120, a universal washer 130, and a spring washer 140.

The fastening bolt 110 and the fastening nut 120 are fastened to fix one or more connection members 1 and 2. In such a case, the connection members 1 and 2 fixed through the fastening bolt 110 and the fastening nut 120 may be a tab 1 or a busbar 2 used when a core pack including a plurality of battery cells and a battery management system (BMS) are connected to each other. For example, a first connection member may be the tab 1 connected to an electrode of the core pack including the plurality of battery cells, and a second connection member may be the busbar 2 connected to the battery management system (BMS).

The universal washer 130 may be interposed beneath the connection members 1 and 2, and the spring washer 140 may be interposed above the connection members 1 and 2. The spring washer 140 has a coil shape twisted like a spring, and thus prevents loosening and detachment by a force caused by a shape being pressed. According to an embodiment of the present disclosure, the universal washer 130 may be used to connect a core pack including a plurality of battery cells and a BMS to form a battery pack (not illustrated). In embodiments, the universal washer 130 may be interposed between the fastening bolt 110 and the fastening nut 120 for fixing the tab connected to an electrode of the core pack and the bus bar connected to the BMS to be in contact with the lower surface of the tab and the bus bar.

The structure and function of the universal washer 130 are described herein in detail with reference to other drawings.

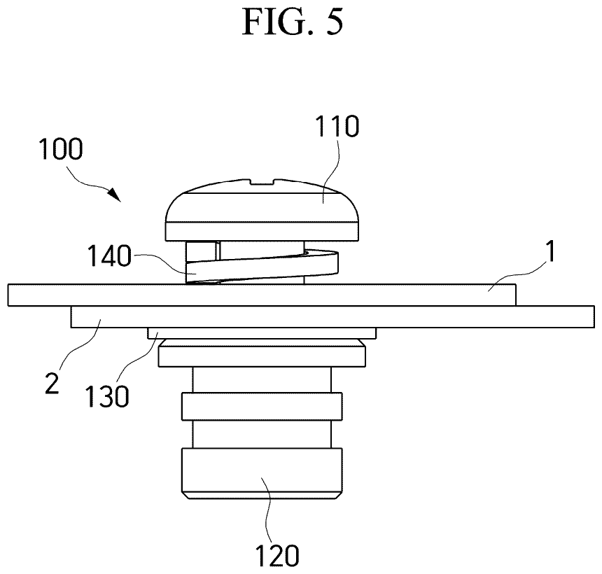

FIG. 5 is a diagram illustrating a state in which the fastening apparatus according to an embodiment of the present disclosure is flatly coupled.

Referring to FIG. 5, it can be confirmed that the fastening apparatus 100 according to an embodiment of the present disclosure is well-coupled to the connection members 1 and 2 flatly. In this case, as in the fastening apparatus 10 in the related art of FIG. 2, the coupling portion of the connection members 1 and 2 and the fastening nut 120 is in good contact as a whole, so that stable contact resistance can be secured.

Unlike the fastening apparatus 10 in the related art, the fastening apparatus 100 according to an embodiment of the present disclosure can secure stable contact resistance even though the fastening apparatus 100 is unevenly coupled to the connection members 1 and 2, which is described with reference to the following drawings.

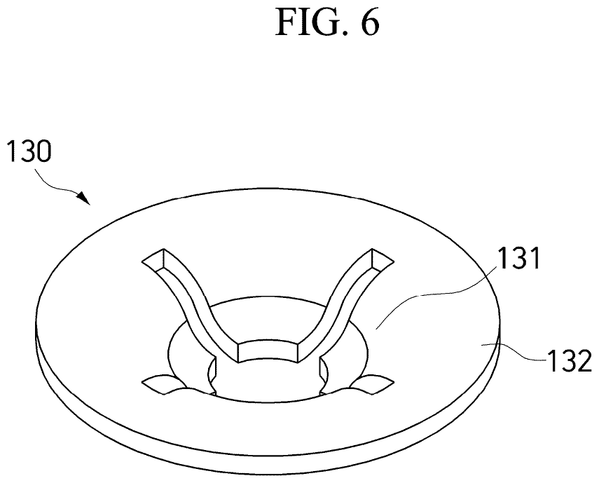

FIG. 6 is a diagram illustrating the universal washer of the fastening apparatus according to an embodiment of the present disclosure.

Referring to FIG. 6, the universal washer 130 of the fastening apparatus 100 according to an embodiment of the present disclosure is interposed to be in contact with a lower surface of the connection members 1 and 2 and is formed with a through hole through which a shaft at the lower part of a head of the fastening bolt 110 passes, a concave curved portion 131 is formed in a peripheral portion of the through hole in the direction of travel of the shaft of the fastening bolt, and a flat rim portion 132 is formed on the rim of the fastening bolt 110.

In this way, the universal washer 130 supplements the unstable flatness of the connection members 1 and 2 by forming the curved portion 131, thereby securing stable contact resistance even though the fastening apparatus 100 and the connection members 1 and 2 are unevenly coupled. The rim portion 132 serves to ensure that the universal washer 130 maintains contact with the lower surface of the connection members 1 and 2 as a whole.

In embodiments, in the universal washer 130, the curved portion 131 may be divided into a plurality of parts. When the curved portion 131 is divided into the plurality of parts, it serves as a spring, thereby maintaining a strong fastening force through a tensile force after the fastening bolt 110 and the fastening nut 120 are coupled. In embodiments, the curved portion 131 may be divided into three to five parts in order to maximize the spring function.

The universal washer 130 may be formed by pressing a plate material in which the heights of divided bottom surfaces of the curved portion 130 may be configured differently. In embodiments, in order to maximize the spring performance of the universal washer 130, the size of an inner circumferential surface of the curved portion 130 may be formed smaller than the size of the outer circumferential surface of the shaft of the fastening bolt 110. The universal washer 130 may require surface processing, but may be formed by casting because the universal washer 130 can be used for both direct and indirect fastening with the fastening bolt 110. In embodiments, the universal washer 130 may be made of an elastic metal material having good pressing processability and elasticity such as copper or nickel.

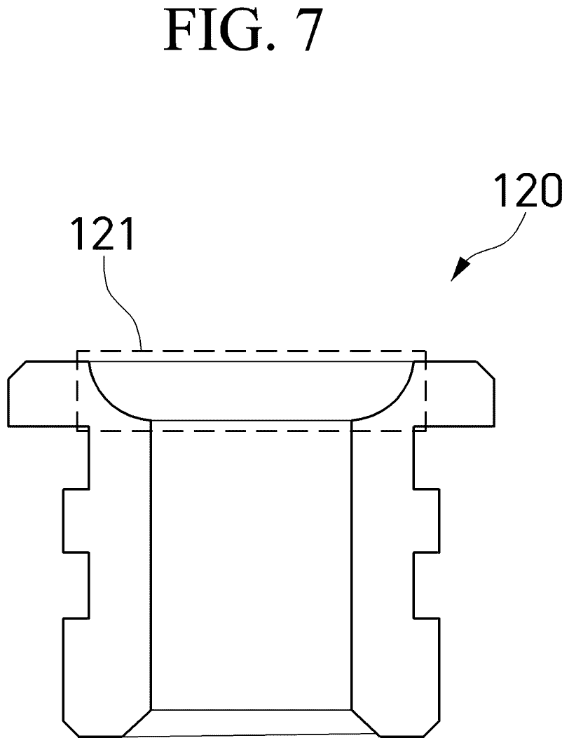

FIG. 7 is a diagram illustrating the fastening nut of the fastening apparatus according to an embodiment of the present disclosure.

Referring to FIG. 7, the fastening nut 120 of the fastening apparatus 100 according to an embodiment of the present disclosure may have a curved shape 121 formed therein to correspond to the curved portion 131. As described herein, the universal washer 130 supplements the unstable flatness of the connection members 1 and 2 by forming the curved portion 131, and the fastening nut 120 can more effectively supplement the flatness of the connection members 1 and 2 by forming the curved shape 121 therein to correspond to the curved portion 131.

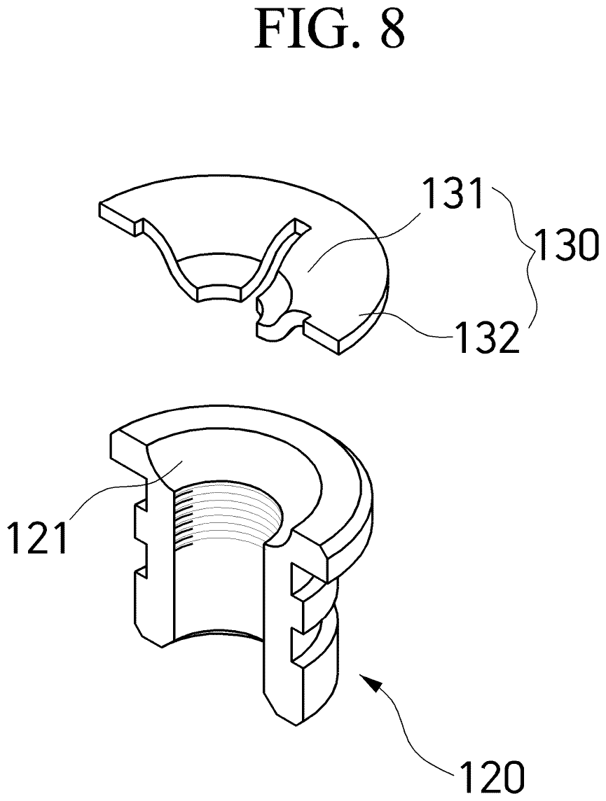

FIG. 8 is a diagram illustrating a state in which the universal washer of the fastening apparatus according to an embodiment of the present disclosure is seated on an upper part of the fastening nut.

Referring to FIG. 8, in a state in which the universal washer 130 is placed on the fastening nut 120 so that the curved portion 131 of the universal washer 130 is seated on the curved shape 121 of the fastening nut 120, the fastening bolt 110 and the fastening nut 120 may be fastened. In embodiments, the fastening nut 120 is not formed with an internal thread, and when the fastening bolt 110 is fastened, the internal thread may be formed by tapping of an external thread formed on a shaft of the fastening bolt 110. In such a case, after the coupling with the fastening nut is made by the tapping of the fastening bolt 110, the curved portion of the universal washer 130 is divided into a plurality of parts and serves as a spring, so that a tensile force is applied in the direction opposite to the direction of travel of the fastening bolt 110, thereby minimizing deformation between the connection members 1 and 2 and further strengthening the fastening force of the bolt.

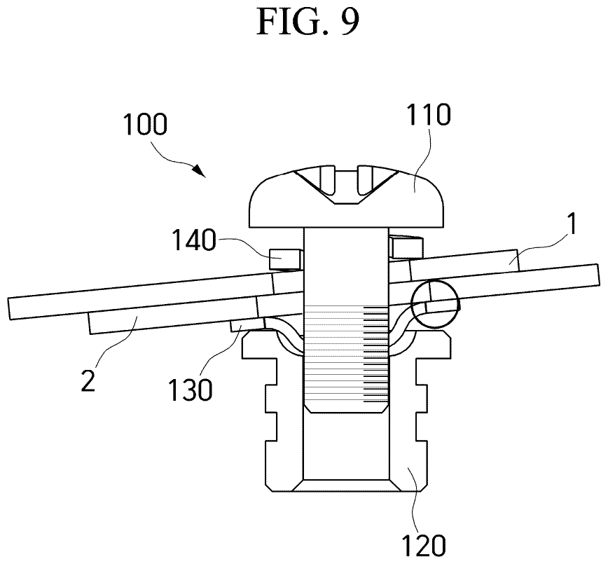

FIG. 9 is a diagram illustrating a state in which the fastening apparatus according to an embodiment of the present disclosure is unevenly coupled.

FIG. 9 illustrates a cross-sectional view of the fastening apparatus 100 according to an embodiment of the present disclosure in an unevenly coupled state with the connection members 1 and 2. As illustrated in FIG. 9, even though the fastening apparatus 100 and the connection members 1 and 2 are unevenly coupled due to the curved surface 131 of the universal washer 130 and the curved shape 121 of the fastening nut 120, the universal washer 130 is tilted together with the connection members 1 and 2, so that the universal washer 130 and the connection members 1 and 2 are maintained in contact as a whole.

To explain comprehensively again, the fastening apparatus 100 according to an embodiment of the present disclosure primarily compensates for flatness through the spring washer 140 when the fastening force of the fastening bolt 110 is transmitted from above, and when an appropriate torque is reached, the bottom surface of the head of the fastening bolt 110, the spring washer 140, and the surface of the connection members 1 and 2 make planar contact with one another, and secondarily, the flatness of the connection members 1 and 2 is compensated for by the shape of the divided curved portion 131 of the universal washer 130 and the curved shape of the fastening nut 120, thereby stably securing contact resistance.

Although the present disclosure has been described herein in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A universal washer comprising:
a through hole through which a shaft at a lower part of a head of a fastening bolt passes;
a concave curved portion formed in a peripheral portion of the through hole in a direction of travel of the shaft of the fastening bolt; and
a flat rim portion formed on a rim of the universal washer, wherein the universal washer is configured to be interposed between the fastening bolt and a fastening nut for fixing one or more connection members such that the universal washer is in contact with a lower surface of the one or more connection member.

2. The universal washer as claimed in claim 1, wherein, in a state in which the universal washer is placed on the fastening nut so that the concave curved portion is seated on a curved shape of the fastening nut, the fastening bolt and the fastening nut are fastened, the curved shape being formed in the fastening nut to correspond to the concave curved portion.

3. The universal washer as claimed in claim 1, wherein the concave curved portion is divided into a plurality of parts.

4. The universal washer as claimed in claim 3, wherein a size of an inner circumferential surface of the concave curved portion is smaller than a size of an outer circumferential surface of the shaft of the fastening bolt.

5. The universal washer as claimed in claim 1, wherein the universal washer is made of an elastic metal material.

6. The universal washer as claimed in claim 1, wherein the one or more connection members comprise a first connection member and a second connection member.

7. The universal washer as claimed in claim 6, wherein the first connection member is a tab connected to an electrode of a core pack comprising a plurality of battery cells.

8. The universal washer as claimed in claim 7, wherein the second connection member is a busbar connected to a battery management system (BMS).

9. A fastening apparatus comprising:
a fastening bolt;
a fastening nut fastened with the fastening bolt to fix one or more connection members; and
a universal washer interposed to be in contact with a lower surface of the one or more connection members and formed with a through hole through which a shaft at a lower part of a head of the fastening bolt passes, a concave curved portion being formed in a peripheral portion of the through hole in a direction of travel of the shaft of the fastening bolt, and a flat rim portion being formed on a rim of the universal washer.

10. The fastening apparatus as claimed in claim 9, wherein the fastening nut has a curved shape formed therein to correspond to the concave curved portion, and
in a state in which the universal washer is placed on the fastening nut so that the concave curved portion of the universal washer is seated on the curved shape of the fastening nut, the fastening bolt and the fastening nut are fastened.

11. The fastening apparatus as claimed in claim 9, wherein the concave curved portion of the universal washer is divided into a plurality of parts.

12. The fastening apparatus as claimed in claim 11, wherein in the universal washer, a size of an inner circumferential surface of the concave curved portion is smaller than a size of an outer circumferential surface of the shaft of the fastening bolt.

13. The fastening apparatus as claimed in claim 9, wherein the universal washer is made of an elastic metal material.

14. The fastening apparatus as claimed in claim 9, further comprising:
a spring washer interposed above the one or more connection members.

15. The fastening apparatus as claimed in claim 9, wherein the fastening nut is not formed with an internal thread, and when the fastening bolt is fastened, the internal thread is formed by tapping of an external thread formed on the shaft of the fastening bolt.

16. The fastening apparatus as claimed in claim 9, wherein the one or more connection members comprise a first connection member and a second connection member.

17. The fastening apparatus as claimed in claim 16, wherein the first connection member is a tab connected to an electrode of a core pack comprising a plurality of battery cells.

18. The fastening apparatus as claimed in claim 17, wherein the second connection member is a busbar connected to a battery management system (BMS).

19. A battery pack comprising the universal washer as claimed in claim 1.

20. The battery pack as claimed in claim 19, wherein the universal washer is interposed between the fastening bolt and the fastening nut for fixing a tab connected to an electrode of a core pack including a plurality of battery cells and a bus bar connected to a battery management system (BMS) to be in contact with a lower surface of the tab and the bus bar.
